(19) United States
(12) Patent Application Publication
(10) Pub. No.: US 2021/0056771 A1
(43) Pub. Date: Feb. 25, 2021

(54) CONNECTIVITY SYSTEM FOR INTERNAL COMBUSTION ENGINE WITH AFTERTREATMENT SYSTEM

(71) Applicant: Cummins Emission Solutions Inc., Columbus, IN (US)

(72) Inventor: Kenneth R. Federle, Columbus, IN (US)

(73) Assignee: Cummins Emission Solutions Inc., Columbus, IN (US)

(21) Appl. No.: 16/965,489

(22) PCT Filed: Jan. 28, 2019
(86) PCT No.: PCT/US2019/015337

§ 371 Date: Jul. 28, 2020

Related U.S. Application Data
(60) Provisional application No. 62/623,860, filed on Jan. 30, 2018.

(51) Int. Cl. G07C 5/00; F01N 3/20; G07C 5/08; H04B 1/02; H04W 76/10

(52) U.S. Cl. CPC G07C 5/008; F01N 3/2066; G07C 5/085; H04W 84/12; H04W 76/10; F01N 2610/1433; H04B 1/02

(57) ABSTRACT

A connectivity system includes an engine control module, a pump assembly remote from the engine control module, and a connectivity unit mounted to the pump assembly. The connectivity unit is communicatively coupled to the engine control module and configured to transmit data received from the engine control module to a device external to a vehicle with which the connectivity system is associated.

### CROSS-REFERENCE TO RELATED APPLICATIONS

The present application claims priority to U.S. Provisional Application No. 62/623,860, filed on Jan. 30, 2018, the entirety of which is incorporated by reference herein.

### TECHNICAL FIELD

The present application relates generally to the field of connectivity systems for internal combustion engines.

### BACKGROUND

For internal combustion engines, such as diesel engines, nitrogen oxide (NOₓ) compounds may be emitted in the exhaust. To reduce NOₓ emissions, a selective catalytic reduction (SCR) process may be implemented to convert the NOₓ compounds into more neutral compounds, such as diatomic nitrogen, water, or carbon dioxide, with the aid of a catalyst and a reductant. The catalyst may be included in a catalyst chamber of an exhaust system, such as that of a vehicle or power generation unit. A reductant, such as anhydrous ammonia or urea, is typically introduced into the exhaust gas flow prior to the catalyst chamber. To introduce the reductant into the exhaust gas flow for the SCR process, an SCR system may dose or otherwise introduce the reductant through a doser that vaporizes or sprays the reductant into an exhaust pipe of the exhaust system up-stream of the catalyst chamber. The SCR system may include one or more sensors to monitor conditions within the exhaust system. In addition, an engine control module may also include one or more sensors to monitor conditions within or associated with the engine.

### SUMMARY

Implementations described herein relate to connectivity systems for engines with aftertreatment systems.

In one embodiment, a connectivity system is disclosed. The connectivity system includes an engine control module, a pump assembly remote from the engine control module, and a connectivity unit mounted to the pump assembly. The connectivity unit is communicatively coupled to the engine control module and configured to transmit data received from the engine control module to a device external to a vehicle with which the connectivity system is associated.

In another embodiment, a method is disclosed. The method includes receiving, by a connectivity unit of a connectivity system, data from an engine control module of the connectivity system. The connectivity unit is mounted to a pump assembly and the pump assembly is located remote from the engine control module. The method also includes establishing, by the connectivity unit, a wireless connection with a device external to a vehicle with which the connectivity system is associated and transmitting, by the connectivity unit, the data received from the engine control module to the device upon establishment of the wireless connection.

In yet another embodiment, a connectivity system is disclosed. The connectivity system includes a pump assembly having a main body, an electrical connector mounted to the main body, and a connectivity unit mounted to the main body. The connectivity unit is configured to receive engine or aftertreatment data from an engine control module via the electrical connector. The connectivity unit is further configured to transmit the engine or aftertreatment data, upon establishing a wireless connection, to a device external to a vehicle with which the connectivity system is associated. The pump assembly is remote from the engine control module.

These and other features, together with the organization and manner of operation thereof, will become apparent from the following detailed description when taken in conjunction with the accompanying drawings, wherein like elements have like numerals throughout the several drawings described below.

### BRIEF DESCRIPTION

The details of one or more implementations are set forth in the accompanying drawings and the description below. Other features, aspects, and advantages of the disclosure will become apparent from the description, the drawings, and the claims, in which:

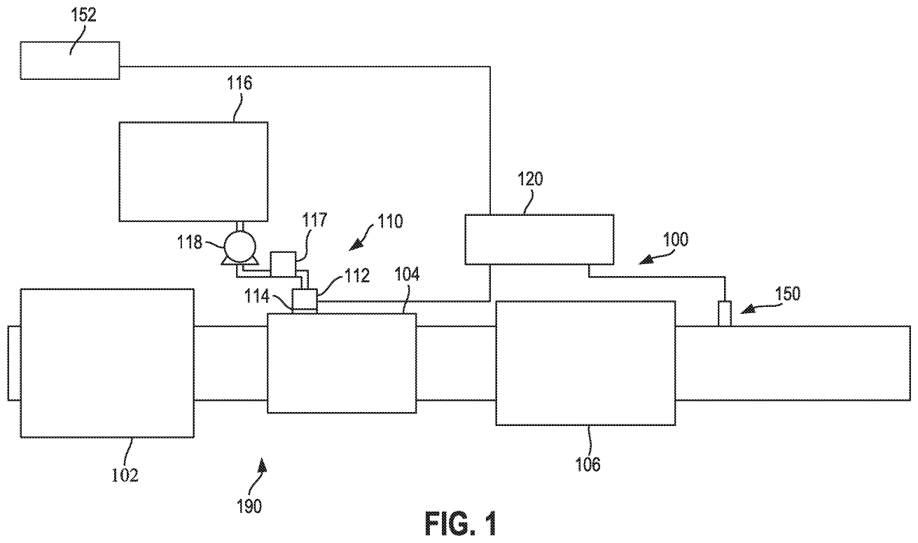

FIG. 1 is a block schematic diagram of an example selective catalytic reduction system having an example reductant delivery system for an exhaust system.

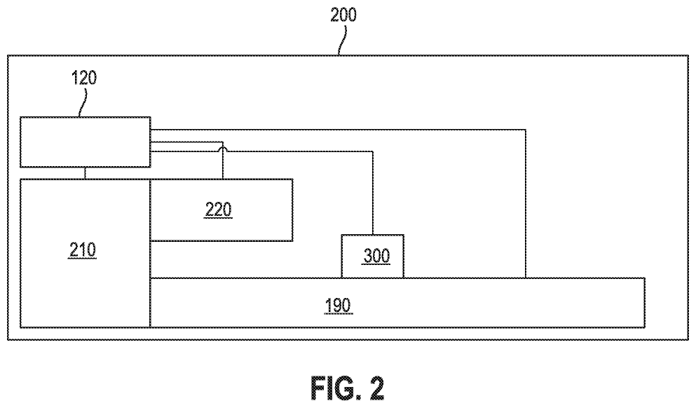

FIG. 2 is a block schematic diagram of a vehicle incorporating the selective catalytic reduction system and exhaust system of FIG. 1 and a connectivity system;

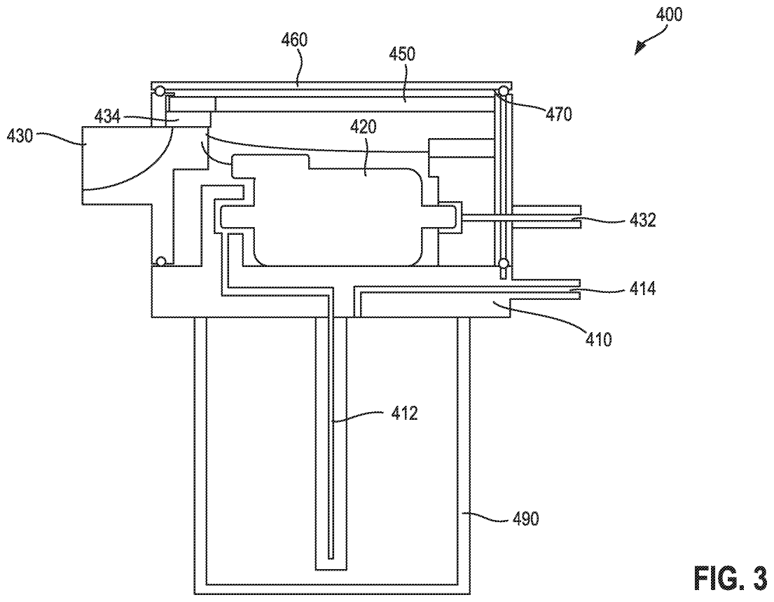

FIG. 3 is a schematic diagram of an implementation of a pump control unit integrated into a pump of the selective catalytic reduction system of FIG. 1;

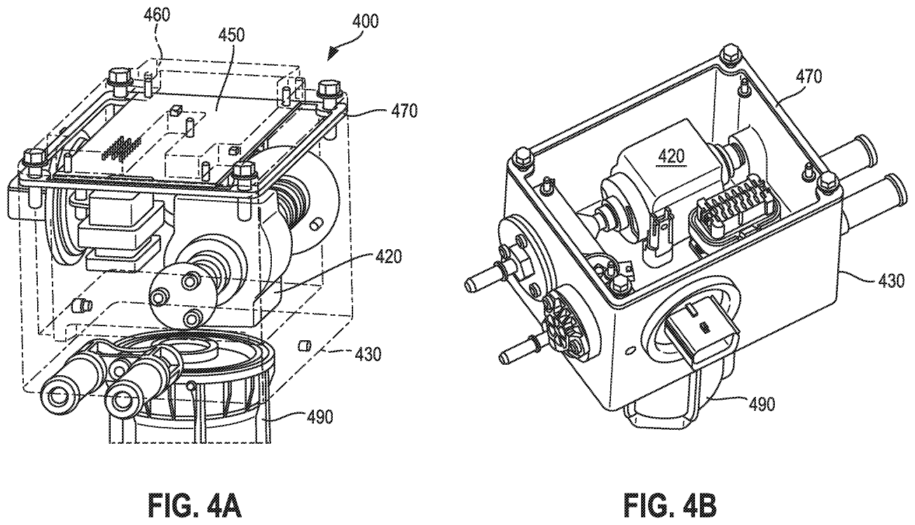

FIG. 4A is a perspective diagram of a smart controller integrated into the pump of FIG. 3;

FIG. 4B is another perspective diagram of the smart controller integrated into the pump of FIG. 3;

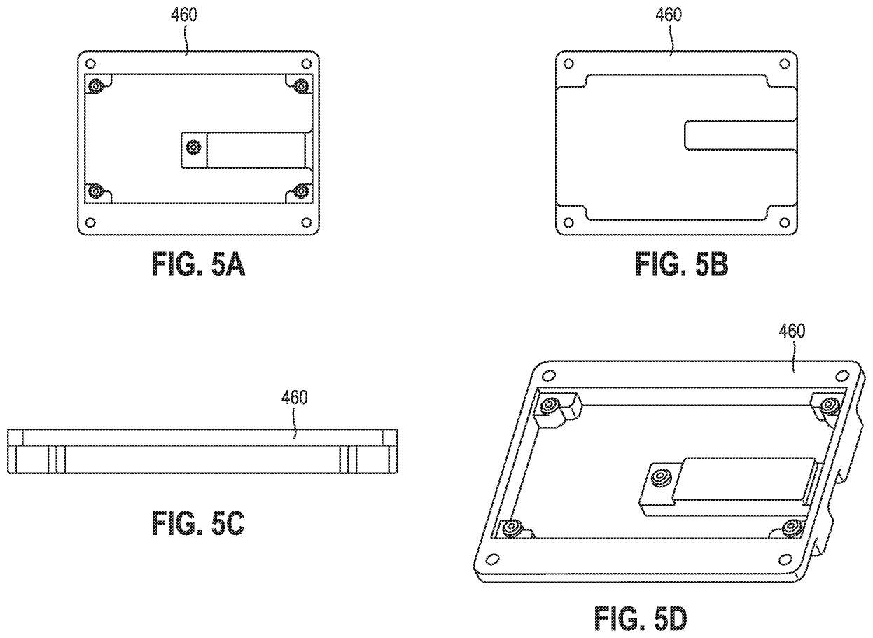

FIG. 5A is a bottom view of a cover for the pump of FIG. 4A;

FIG. 5B is a top view of the cover of FIG. 5A;

FIG. 5C is a front view of the cover of FIG. 5A;

FIG. 5D is a perspective view of the cover of FIG. 5A;

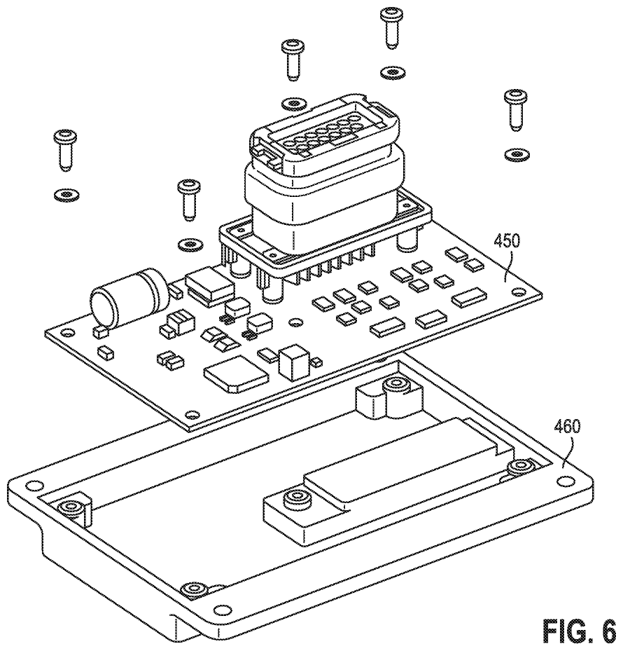

FIG. 6 is an exploded perspective view of the smart controller of FIG. 3 and the cover of FIG. 5A;

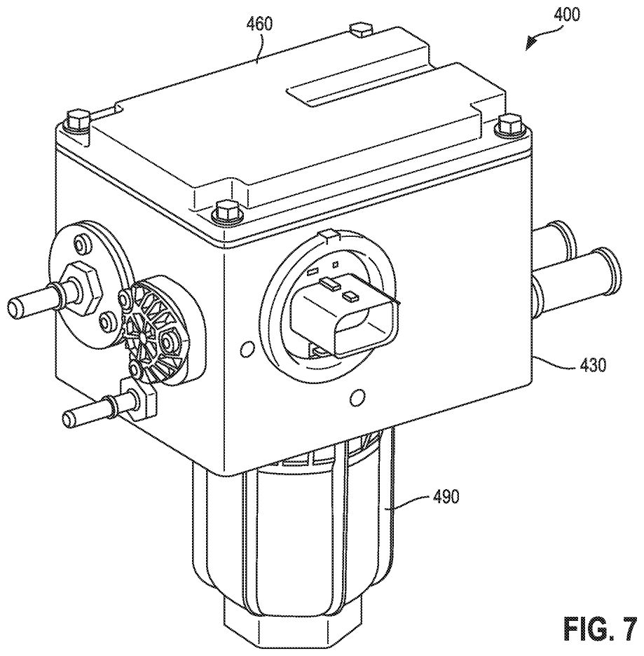

FIG. 7 is a perspective view of the pump of FIG. 3;

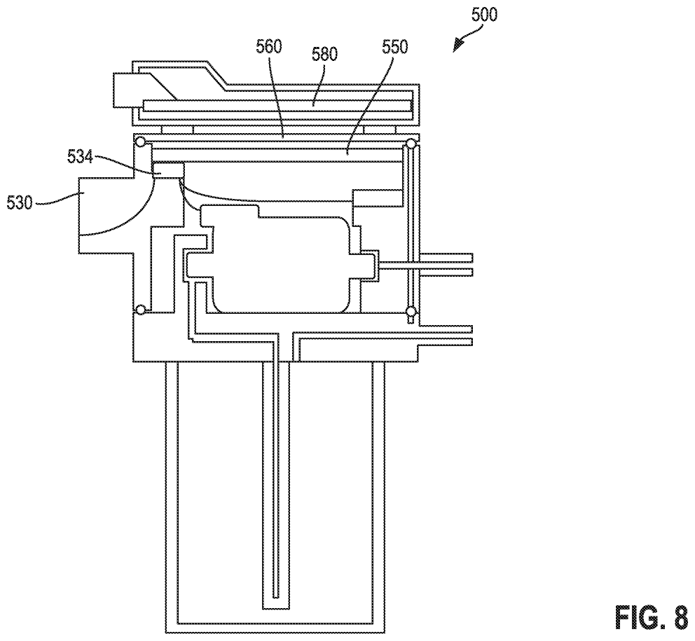

FIG. 8 is a schematic diagram of an implementation of a connectivity unit integrated into a pump of the selective catalytic reduction system of FIG. 1;

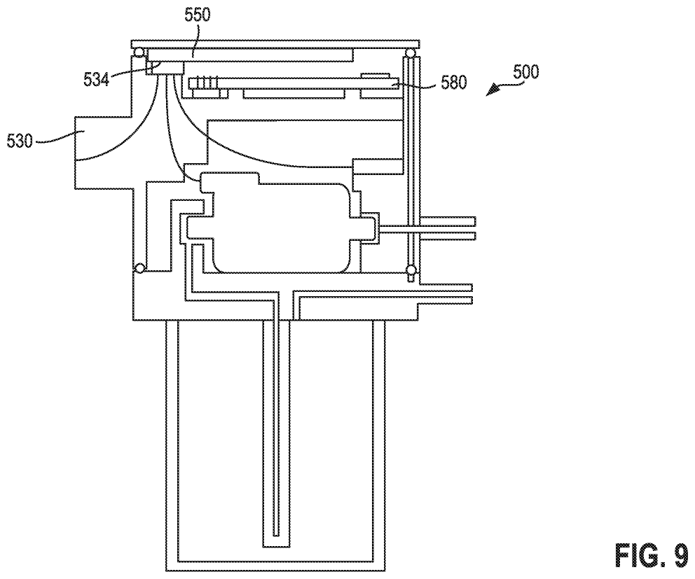

FIG. 9 is another schematic diagram of an implementation of a connectivity unit integrated into a pump of the selective catalytic reduction system of FIG. 1;

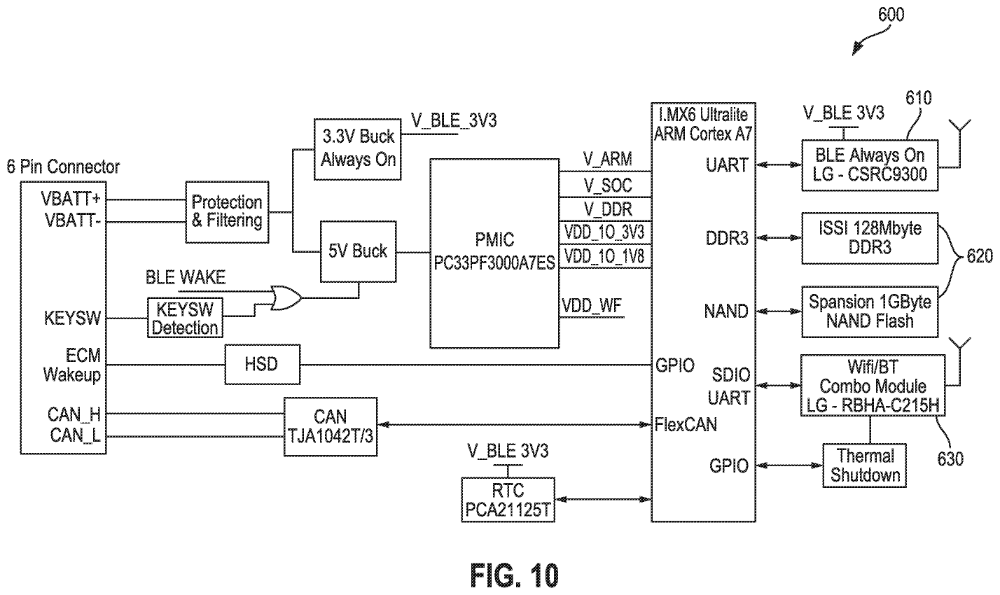

FIG. 10 is a block schematic of components of the connectivity units of FIGS. 8 and 9;

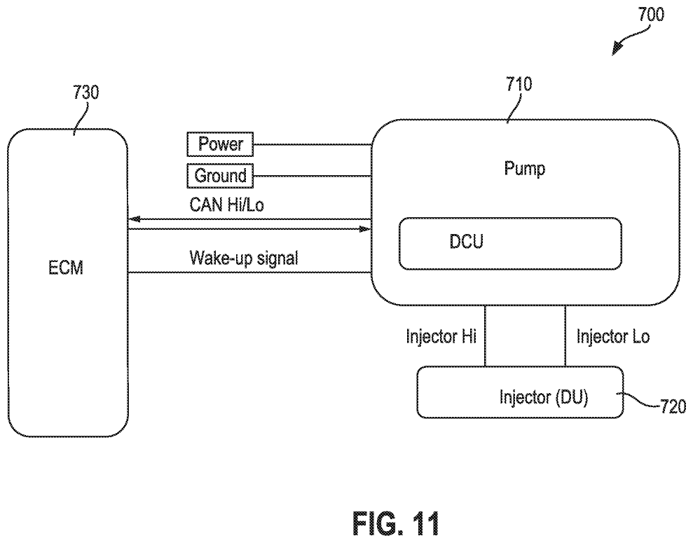

FIG. 11 is a schematic showing communication between an engine control module, a pump having a dosing control module, and an injector; and

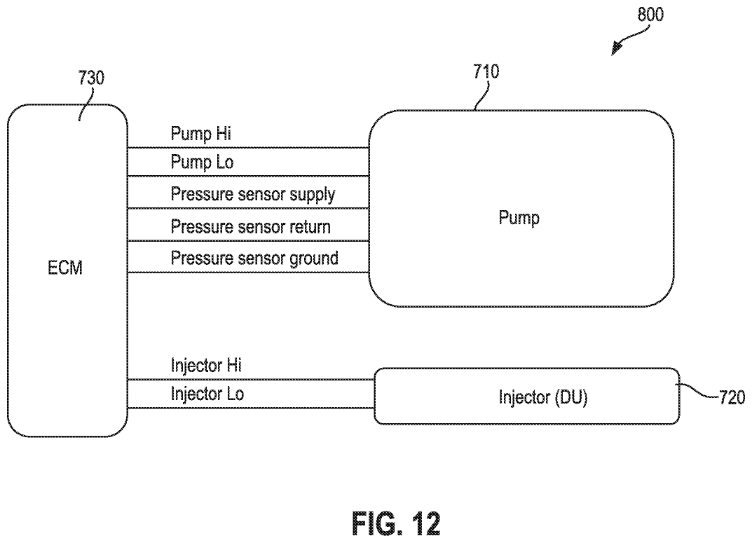

FIG. 12 is another schematic showing communication between an engine control module, a pump having a dosing control module, and an injector.

It will be recognized that some or all of the figures are schematic representations for purposes of illustration. The figures are provided for the purpose of illustrating one or more implementations with the explicit understanding that they will not be used to limit the scope or the meaning of the claims.

### DETAILED DESCRIPTION

Following below are more detailed descriptions of various concepts related to, and implementations of, methods, apparatuses, and systems for connectivity units for engines with aftertreatment systems. The various concepts introduced above and discussed in greater detail below may be implemented in any of numerous ways, as the described concepts are not limited to any particular manner of implementation. Examples of specific implementations and applications are provided primarily for illustrative purposes.

### I. Overview

In some vehicles, connectivity to systems and sub-systems may provide useful diagnostic or analytic data to be exported to external systems. Data can be collected and used by a controller, such as an engine control module (ECM), during operation. However, due to both memory space limitations and a lack of ease of transference of the data to the external system from the vehicle, the collected data may only be temporarily stored and used during operation of the vehicle. An ECM of a vehicle can be subject to high temperatures, high vibrations, and large amounts of interference from the steel and/or cast iron components of the engine, which may not be conducive for connectivity components (e.g., WiFi chipsets, Bluetooth® chipsets, cellular communications chipsets, etc.).

For some vehicles, such as vehicles incorporating a diesel engine, an exhaust aftertreatment system, such as a selective catalytic reduction system, can be implemented to reduce emissions. The selective catalytic reduction system can include a pump and a doser. The pump and the doser provide reductant, such as liquid urea or diesel exhaust fluid (DEF), from a reductant supply tank to be sprayed by the doser into the exhaust stream. The pump can be used to supply the reductant to the doser. The pump can be mounted close the reductant source, such as a DEF tank. The pump can be located in a low vibration and temperature area on the vehicle. In addition, the pump moves a fluid, which can control the temperature of the pump via heat transfer from the pump. The pump can be discretely driven from an onboard controller or via a J1939 data link to the engine control module (ECM).

As the environment of the pump is relatively controlled and stable, it can serve as a location for a connectivity system for communications to and/or from the ECM and/or an onboard circuit. The pump can be connected to the ECM via the J1939 data link. This enables engine and other diagnostic data to be stored and/or transferred off the vehicle in an efficient manner. The incremental cost is minimized by using the pump housing to package the electronics in an environment suitable for electronics. In addition, the pump location is outside of the firewall and enables wireless communication.

Data can be transferred off the vehicle continuously via a cellular circuit or can be stored in memory on the pump and transferred when the vehicle is connected to Wi-Fi or Bluetooth®.

Thus, in some implementations, a vehicle system or connectivity system for a vehicle is provided. The vehicle system or connectivity system can include: an engine control module communicatively coupled to a sensor for an engine; a pump assembly located remote from an engine compartment of the vehicle and a connectivity unit mounted to the pump assembly, the connectivity unit communicatively coupled to the engine control module and configured to transmit data from the engine control module to a device separate from the vehicle, the data including data from the sensor for the engine or data processed from the data from the sensor for the engine. The connectivity unit can include a cellular transmitter, a WiFi transmitter, and/or a Bluetooth® transmitter. The connectivity unit can also be configured to store the data received from the engine control module in a memory. In some implementations, the vehicle system can further include an actuator, and the engine control module is communicatively coupled to the actuator.

### II. Overview of Aftertreatment System

FIG. 1 depicts an aftertreatment system 100 having an example reductant delivery system 110 for an exhaust system 190. The aftertreatment system 100 includes a particulate filter, for example a diesel particulate filter (DPF) 102, the reductant delivery system 110, a decomposition chamber or reactor pipe 104, a SCR catalyst 106, and a sensor 150.

The DPF 102 is configured to remove particulate matter, such as soot, from exhaust gas flowing in the exhaust system 190. The DPF 102 includes an inlet, where the exhaust gas is received, and an outlet, where the exhaust gas exits after having particulate matter substantially filtered from the exhaust gas and/or converting the particulate matter into carbon dioxide.

The decomposition chamber 104 is configured to convert a reductant, such as urea or diesel exhaust fluid (DEF), into ammonia. The decomposition chamber 104 is associated with the reductant delivery system 110 having a doser 112 configured to dose the reductant into the decomposition chamber 104. In some implementations, the reductant is injected upstream of the SCR catalyst 106. The reductant droplets then undergo the processes of evaporation, thermolysis, and hydrolysis to form gaseous ammonia within the exhaust system 190. The decomposition chamber 104 includes an inlet in fluid communication with the DPF 102 to receive the exhaust gas containing NOₓ emissions and an outlet for the exhaust gas, NOₓ emissions, ammonia, and/or remaining reductant to flow to the SCR catalyst 106.

The decomposition chamber 104 includes the doser 112 mounted to the decomposition chamber 104 such that the doser 112 may dose the reductant into the exhaust gases flowing in the exhaust system 190. The doser 112 may include an insulator 114 interposed between a portion of the doser 112 and the portion of the decomposition chamber 104 to which the doser 112 is mounted. The doser 112 is fluidly coupled to one or more reductant sources 116. In some implementations, a pump 118 may be used to pressurize the reductant from the reductant source 116 for delivery to the doser 112. In some implementations, a filter assembly 117 can be positioned between the reductant source 116 and the doser 112. The filter assembly 117 can be upstream or downstream of the pump 118. In other implementations, the filter assembly 117 can be integrated into the pump 118. In still other implementations, the filter assembly 117 can be integrated into the doser 112 and/or reductant source 116. The filter assembly 117 can include a filter housing, a filter media, and one or more valves, as described in greater detail below.

The doser 112 and the pump 118 are also electrically or communicatively coupled to a controller 120. In some implementations, the one or more valves can be electrically or communicatively coupled to the controller 120. The controller 120 is configured to control the doser 112 to dose reductant into the decomposition chamber 104. The controller 120 may also be configured to control the pump 118 and/or the filter assembly 117. The controller 120 may include a microprocessor, an application-specific integrated circuit (ASIC), a field-programmable gate array (FPGA), etc., or combinations thereof. The controller 120 may include memory which may include, but is not limited to, electronic, optical, magnetic, or any other storage or transmission device capable of providing a processor, ASIC, FPGA, etc. with program instructions. The memory may include a memory chip, Electrically Erasable Programmable Read-Only Memory (EEPROM), erasable programmable read only memory (EPROM), flash memory, or any other suitable memory from which the controller 120 can read instructions. The instructions may include code from any suitable programming language.

The SCR catalyst 106 is configured to assist in the reduction of NOₓ emissions by accelerating a NOₓ reduction process between the ammonia and the NOₓ of the exhaust gas into diatomic nitrogen, water, and/or carbon dioxide. The SCR catalyst 106 includes inlet in fluid communication with the decomposition chamber 104 from which exhaust gas and reductant is received and an outlet in fluid communication with an end of the exhaust system 190.

The exhaust system 190 may further include an oxidation catalyst, for example a diesel oxidation catalyst (DOC), in fluid communication with the exhaust system 190 (e.g., downstream of the SCR catalyst 106 or upstream of the DPF 102) to oxidize hydrocarbons and carbon monoxide in the exhaust gas.

In some implementations, the DPF 102 may be positioned downstream of the decomposition chamber or reactor pipe 104. For instance, the DPF 102 and the SCR catalyst 106 may be combined into a single unit, such as a DPF with SCR-coating (SDPF). In some implementations, the doser 112 may instead be positioned downstream of a turbocharger or upstream of a turbocharger.

The sensor 150 may be coupled to the exhaust system 190 to detect a condition of the exhaust gas flowing through the exhaust system 190. In some implementations, the sensor 150 may have a portion disposed within the exhaust system 190, such as a tip of the sensor 150 may extend into a portion of the exhaust system 190. In other implementations, the sensor 150 may receive exhaust gas through another conduit, such as a sample pipe extending from the exhaust system 190. While the sensor 150 is depicted as positioned downstream of the SCR catalyst 106, it should be understood that the sensor 150 may be positioned at any other position of the exhaust system 190, including upstream of the DPF 102, within the DPF 102, between the DPF 102 and the decomposition chamber 104, within the decomposition chamber 104, between the decomposition chamber 104 and the SCR catalyst 106, within the SCR catalyst 106, or downstream of the SCR catalyst 106. In addition, two or more sensors 150 may be utilized for detecting a condition of the exhaust gas, such as two, three, four, five, or six sensors 150 with each sensor 150 located at one of the foregoing positions of the exhaust system 190. In some implementations, one or more actuators 152, such as actuators to move a valve (e.g., an EGR valve) or to control operation of other devices, may be included for the exhaust system 190 in addition to the one or more sensors 150. In some vehicles, over 50 and up to 70 sensors and/or actuators may be implemented for the engine and/or exhaust system 190.

### III. Example Connectivity Systems

FIG. 2 depicts a block schematic of a vehicle 200 having an engine 210, a transmission 220, the exhaust system 190 (including the aftertreatment system 100), the controller 120, and a connectivity system 300. The exhaust system 190 and the controller 120 can be constructed in substantially the same manner as described above in reference to FIG. 1. The vehicle 200 can be any type of vehicle, such as a commercial truck, a personal truck, a mining vehicle, a ship, etc. Components of the engine 210 and the transmission 220 are communicatively coupled to the controller 120 along with the components of the exhaust system 190. Thus, sensors, actuators, and/or other devices of the engine 210 and/or transmission 220 communicate data to and/or from the controller 120, such as an engine control module. The controller 120 is communicatively coupled to the connectivity system 300 to transmit and/or receive data via the connectivity system 300. The connectivity system 300 provides improved visibility to product applications and product performance, consolidates multiple connected functions into a single device, increases the capability of the service function, and provides a solution which is packaged into a single system component, such as the pump 118 of FIG. 1.

Referring generally to FIGS. 3-7, an implementation of a smart controller 450 integrated into a pump assembly 400 of a selective catalytic reduction system is shown. The pump assembly 400 can be similar to the pump 118 of FIG. 1. In the implementation shown, the pump assembly 400 includes a base 410 that includes a pump inlet 412 and a return line 414. In some implementation, the base 410 can be an aluminum base incorporating a molded pump inlet (e.g., the pump inlet 412). In other implementations, the base 410 can be made of a metallic, plastic, or other material. A pump 420 is mounted and fluidly coupled to the pump inlet 412 of the base 410 and is contained within a main body 430. The main body 430 includes a pump outlet 432 to which the pump 420 is fluidly coupled to output pumped reductant to a reductant dosing system. In some implementations, the main body 430 can be made of plastic and incorporates a molded pump outlet (e.g., the pump outlet 432) and outlet connector. In other implementations, the main body 430 can be made of other suitable materials. The return line 414 is fluidly coupled to a downstream portion of the pump outlet 432 to return reductant to a reservoir 490 or other reductant source. In some implementations, the pump inlet 412 and the return line 414 can be integrated or otherwise unitarily made with the base 410.

The pump assembly 400 further includes the main body 430 with a smart controller 450 mounted thereto. In some implementations, the main body 430 may be integrally coupled to the base 410 and the pump assembly 400 may include a cover 460 that is separate or the main body 430 may itself have an integral cover and mechanically coupled to a separate base (e.g., the base 410). In some implementations, the cover 460 is a heat sink top or a plastic cover. In other implementations, other suitable materials can be used for the cover 460. In implementations in which the cover 460 is separate, a seal 470 can be used to substantially isolate the interior of the main body 430 from the exterior environment. An implementation of the cover 460 is shown in FIGS. 5A-5D. In some implementations, as shown in FIG. 6, the smart controller 450 (e.g., the smart controller board) is mechanically coupled, such as by screws or bolts, to the cover 460.

The smart controller 450 can include a processing unit and/or a memory. The main body 430 includes an electrical connector 434 that is communicatively coupled to the smart controller 450. In some implementations, a portion of the electrical connector 434 and leadframe can be molded or otherwise formed in the main body 430 such that the smart controller 450 can be communicatively coupled via the electrical connector 434 while the pump assembly 400 remains sealed from the environment. In some implementations, the electrical connector 434 is a J1939 datalink. The electrical connector 434 can be communicatively coupled to an engine control module to transmit and/or receive data from the engine control module. This enables engine data to be stored and/or transferred via the smart controller 450. By positioning the smart controller 450 within the pump assembly 400, the environment for the electronic components of the smart controller 450 can be controlled. For instance, the positioning of the pump assembly 400 can be at a location away from heat sources, such as the engine or other heated aftertreatment components. Similarly, the reductant flowing through the pump 420 can be used to thermodynamically cool and/or hear the electronic components of the smart controller 450. FIG. 7 depicts the pump assembly 400 in an assembled form. In some implementations, the electrical connector 434 may be a single connector and the main body 430 may include a connector passthrough to connect to the engine control module if the smart controller 450 is not associated with the pump assembly 400.

FIGS. 8-9 depict implementations incorporating a connectivity unit 580 into a pump assembly 500, such as the pump assembly 400 of FIGS. 3-7. FIG. 8 depicts the connectivity unit 580 as a separately attachable unit to mount onto a cover 560 (e.g., plastic cover) or heatsink top of an existing pump assembly 500. The connectivity unit 580 may include a right angle connector. FIG. 9 depicts the connectivity unit 580 integrated into the main body 530 of the pump assembly. The connectivity unit 580 can include a processing unit and/or a memory that is part of a connectivity board. In some implementations, the connectivity unit 580 can include compliance pins. In some implementations, the connectivity unit 580 can be communicatively coupled to the smart controller's 550 processing unit and/or memory. The main body 530 can include an electrical connector 534 that is communicatively coupled to the connectivity unit 580 and/or the connectivity unit 580 can be communicatively coupled to the electrical connector 534 via a connection to the smart controller 550. In some implementations, a portion of the electrical connector 534 and/or the connection to the smart controller 550 can be molded or otherwise formed in the main body 530 such that the connectivity unit 580 can be communicatively coupled via the electrical connector 534 while the pump assembly 500 remains sealed from the environment. In some implementations, the electrical connector 534 is a J1939 datalink. The electrical connector 534 can be communicatively coupled to an engine control module to transmit and/or receive data from the engine control module. This enables engine data to be stored and/or transferred via the connectivity unit 580. By positioning the connectivity unit 580 within the pump assembly 500, the environment for the electronic components of the connectivity unit 580 can be controlled. For instance, the positioning of the pump assembly 500 can be at a location away from heat sources, such as the engine or other heated aftertreatment components. Similarly, the reductant flowing through the pump of the pump assembly 500 can be used to thermodynamically cool and/or heat the electronic components of the connectivity unit 580.

In addition, as the pump assembly 500 can be located outside of a firewall and/or away from the ferrous engine elements, such as steel and/or cast iron components that may not be conducive for connectivity components, to permit wireless communication. Data can be transferred to the connectivity unit 580 from the engine control module to be transmitted from the vehicle. In some implementations, the transferred data can be transmitted from the connectivity unit 580 responsive to receiving the data or can be stored in a memory and transferred when the vehicle is later connected. In some implementations, the connectivity unit 580 can also be used to transmit data to the engine control module, such as a firmware update, configuration data, etc. In still further implementations, the memory of the connectivity unit 580 can store pump and/or injector controls and/or algorithms.

The connectivity unit 580 can be utilized to store and/or transmit engine data (e.g., raw engine sensor data, processed engine sensor data, etc.), aftertreatment data (e.g., raw aftertreatment sensor data, processed aftertreatment sensor data, etc.), or other vehicle data. For instance, an engine control module can be positioned within an engine compartment of a vehicle where high temperatures, vibrations, and/or other environmental conditions can affect electrical components. In some implementations, the engine control module can transmit such engine data to the connectivity unit 580 to be transferred and/or stored by the connectivity unit 580 that is located in a location separate from the engine compartment. Thus, the electronic components for the engine control module can be reduced while still permitting data logging of engine data by the connectivity unit 580. The connectivity unit 580 can transfer the engine data responsive to receiving the engine data or may store the engine data and transfer the engine data at a later time. In some implementations, the engine data can be wirelessly transmitted to a device within or near the vehicle, such as a mobile phone, a tablet, a computer, etc. In other implementations, the engine data can be wirelessly transmitted to a device remote from the vehicle, such as a remote technical support or diagnostic server, etc.

Similarly, aftertreatment data can be transmitted from the engine control module to the connectivity unit 580 to be transferred and/or stored by the connectivity unit 580 for data logging of aftertreatment data by the connectivity unit 580. The connectivity unit 580 can transfer the aftertreatment data responsive to receiving the aftertreatment data or may store the aftertreatment data and transfer the aftertreatment data at a later time. In some implementations, the connectivity unit 580 can wireless transmit to a device within or near the vehicle, such as a mobile phone, a tablet, a computer, etc. In other implementations, the connectivity unit 580 can wireless transmit to a device remote from the vehicle, such as a remote technical support or diagnostic server, etc.

FIG. 10 depicts a schematic of components of a connectivity unit 600 such as the connectivity unit 580 of FIGS. 8-9 and can include a cellular network transmitter or transceiver 610, a memory 620, a WiFi transmitter or transceiver and/or a Bluetooth® transmitter or transceiver 630. FIGS. 11-12 depict communication configurations 700, 800 between an engine control module 730, a pump assembly 710 having a dosing control module, and an injector 720. In some implementations, such as the communication configuration 700, the engine control module 730 can communicate with the pump assembly 710 having a dosing control unit to send high and low data values for the dosing control unit to control the pump and the injector 720. The engine control unit can also send a wake-up signal to start the dosing control unit and/or start the pump assembly 710.

In some implementations, the connectivity units described herein can be used to improve visibility to product applications and/or product performance by transmitting component performance data to an analytics system. The connectivity unit can provide for remote calibration of the engine control module, injector, dosing control unit/smart controller, and/or other components of the vehicle that are in communication with the connectivity unit. For instance, a calibration device can be communicatively coupled to the connectivity unit, such as via cellular data, Bluetooth®, WiFi or other wireless connection. The calibration device can receive data from one or more components of the vehicle and/or transmit parameter values or data files to the connectivity unit to calibrate the one or more components. In addition, one or more connected applications can be implemented on a remote device, such as a cell phone, tablet, server, or computer in communication with the connectivity unit. Such connectivity applications can display real-time performance data and/or processed performance data of the one or more components in communication with the connectivity unit. In some implementations, data can be stored in a memory, such as an on-board memory of the connectivity unit or smart controller for data logging. The stored data can be processed by the smart controller and/or can be transmitted to a remote device using the connectivity unit, such as operating as a wireless datalink. In some implementations, the connectivity unit can include telematics data, such as GPS coordinates, with the data. In some instances, the telematics data can be utilized by one or more embedded applications for predictive features (such as engine speed control, fuel consumption control, etc.) based on past, current, and/or upcoming road conditions.

In still further implementations, the connectivity unit can receive transmitted applications to be stored and executed as embedded applications by the smart controller. That is, application data files and/or executables can be transmitted via the connectivity unit to be stored and executed by the smart controller to perform one or more processes of the embedded application (e.g., a diagnostic application, a model based fuel management or optimization application, on-board computation for telematics applications, a road speed management application, an active idle management application, a dynamic environmental data collection application, etc.). In some implementations, the connectivity unit can selectively communicate with a remote device responsive to one or more parameters that are modified by the embedded application, such as when one or more field performance parameters exceed or fall below a corresponding predetermined value.

In some implementations, the connectivity unit can be used for over-the-air updating for firmware of one or more components of the vehicle that are in communication with the connectivity unit. Such components may include the engine control module/controller, a transmission control module/controller, a turbo control module/controller, a dosing control module/controller, the smart controller, the connectivity unit, etc.

The term “controller” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code).

While this specification contains many specific implementation details, these should not be construed as limitations on the scope of what may be claimed, but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, the separation of various system components in the implementations described above should not be understood as requiring such separation in all implementations, and it should be understood that the described components and systems can generally be integrated in a single product or packaged into multiple products embodied on tangible media.

As utilized herein, the term “substantially” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims. Additionally, it is noted that limitations in the claims should not be interpreted as constituting “means plus function” limitations under the United States patent laws in the event that the term “means” is not used therein.

The terms “coupled,” “connected,” and the like as used herein mean the joining of two components directly or indirectly to one another. Such joining may be stationary (e.g., permanent) or movable (e.g., removable or releasable). Such joining may be achieved with the two components or the two components and any additional intermediate components being integrally formed as a single unitary body with one another or with the two components or the two components and any additional intermediate components being attached to one another,

The terms “fluidly coupled,” “in fluid communication,” and the like as used herein mean the two components or objects have a pathway formed between the two components or objects in which a fluid, such as water, air, gaseous reductant, gaseous ammonia, etc., may flow, either with or without intervening components or objects. Examples of fluid couplings or configurations for enabling fluid communication may include piping, channels, or any other suitable components for enabling the flow of a fluid from one component or object to another.

It is important to note that the construction and arrangement of the system shown in the various exemplary implementations is illustrative only and not restrictive in character. All changes and modifications that come within the spirit and/or scope of the described implementations are desired to be protected. It should be understood that some features may not be necessary and implementations lacking the various features may be contemplated as within the scope of the application, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A connectivity system comprising:
an engine control module;
a pump assembly for an aftertreatment system, the pump assembly being remote from the engine control module and configured to deliver reductant to a doser of the aftertreatment system; and
a connectivity unit mounted to the pump assembly, the connectivity unit communicatively coupled to the engine control module and configured to transmit data received from the engine control module to a device external to a vehicle with which the connectivity system is associated.

2. The connectivity system of claim 1, wherein the connectivity unit comprises a cellular transmitter.

3. The connectivity system of claim 1, wherein the connectivity unit comprises a WiFi transmitter.

4. The connectivity system of claim 1, wherein the connectivity unit comprises a Bluetooth® transmitter.

5. The connectivity system of claim 1, wherein the connectivity unit is configured to store the data received from the engine control module in a memory.

6. The connectivity system of claim 1, wherein the engine control module is located within an engine compartment, and wherein the pump assembly is remote from the engine compartment.

7. The connectivity system of claim 1, wherein the connectivity unit is communicably coupled to the engine control module via an electrical connector and a controller mounted within the pump assembly.

8. The connectivity system of claim 1, wherein the connectivity unit is integrated into a main body of the pump assembly.

9. The connectivity system of claim 1, wherein the connectivity unit is coupled to a cover of the pump assembly.

10. The connectivity system of claim 1, wherein the connectivity unit is configured to establish a wireless connection with the device and transmit the data to the device upon establishment of the wireless connection.

11. The connectivity system of claim 1, wherein the connectivity unit is configured to establish a wireless connection with the device and receive calibration data from the device for calibrating a component of the vehicle.

12. The connectivity system of claim 1, wherein the data comprises raw data from the engine control module or processed data obtained by processing the raw data.

13. The connectivity system of claim 1, wherein the connectivity unit is configured to establish a wireless connection with the device and send real-time performance data of a component of the vehicle to display on the device.

14. The connectivity system of claim 1, wherein the connectivity unit is configured to receive over-the-air firmware updates from the device to update firmware of a component of the vehicle.

15. A method comprising:
receiving, by a connectivity unit of a connectivity system, data from an engine control module of the connectivity system, wherein the connectivity unit is mounted to a pump assembly for an aftertreatment system, and wherein the pump assembly is located remote from the engine control module and configured to deliver reductant to a doser of the aftertreatment system;
establishing, by the connectivity unit, a wireless connection with a device external to a vehicle with which the connectivity system is associated; and
transmitting, by the connectivity unit, the data received from the engine control module to the device upon establishment of the wireless connection.

16. The method of claim 15, further comprising:
receiving, by the connectivity unit, calibration data from the device upon the establishment of the wireless connection for calibrating a component of the vehicle; and
calibrating, by the connectivity unit, the component upon receiving the calibration data.

17. The method of claim 15, further comprising:
receiving, by the connectivity unit, an over-the-air firmware update from the device upon the establishment of the wireless connection for updating firmware of a component of the vehicle; and
updating, by the connectivity unit, the firmware of the component upon receiving the over-the-air firmware update.

18. A connectivity system comprising:
a pump assembly for an aftertreatment system, the pump assembly comprising a main body and being configured to deliver reductant to a doser of the aftertreatment system;
an electrical connector mounted to the main body; and
a connectivity unit mounted to the main body,
wherein the connectivity unit is configured to receive engine or aftertreatment data from an engine control module via the electrical connector,
wherein the connectivity unit is configured to transmit the engine or aftertreatment data, upon establishing a wireless connection, to a device external to a vehicle with which the connectivity system is associated; and
wherein the pump assembly is remote from the engine control module.

19. The connectivity system of claim 18, wherein the connectivity unit is integrally mounted to the main body.

20. The connectivity system of claim 18, wherein the connectivity unit is mounted to a cover of the main body.
